(19) United States
(12) Patent Application Publication
(10) Pub. No.: US 2022/0380101 A1
(43) Pub. Date: Dec. 1, 2022

(54) LOW TEMPERATURE SEALABLE BAG

(71) Applicant: CC-Pak LLC, Reno, NV (US)

(72) Inventor: Charles Harder, Oracle, AZ (US)

(73) Assignee: CC-Pak LLC, Reno, NV (US)

(21) Appl. No.: 17/826,953

(22) Filed: May 27, 2022

Related U.S. Application Data
(60) Provisional application No. 63/194,895, filed on May 28, 2021.

(51) Int. Cl. B65D 65/40; B32B 27/08; B32B 27/32; B32B 27/34; B65B 51/10

(52) U.S. Cl. CPC B65D 65/40; B32B 27/08; B32B 27/32; B32B 27/34; B65B 51/10; B32B 2250/04; B32B 2250/24; B32B 2307/732; B32B 2307/31; B32B 2439/46; B32B 2307/748; B65B 2051/105

(57) ABSTRACT

A heat sealable bag may have overlapping layers of a multi-layer film. The inner adjacent layers of the multi-layer film may comprise a sealant layer that allows an open edge of the bag to be heat sealed by temperatures lower than 255 F for a 6-second dwell time, thereby providing safer operation and potentially allowing thinner plastics to be used, with reduced risk of burn-through. The sealant may include a polyolefin plastomer such as an ethylene alpha-olefin resin.

### CROSS REFERENCE TO RELATED APPLICATIONS

This application claims priority to U.S. Provisional Application No. 63/194,895 filed 28 May 2021, the entire contents of which are herein incorporated by reference.

### FIELD OF THE INVENTION

The present invention relates to a bag sealing system for heat sealing plastic bags. In particular, the bag sealing system may be a vacuum sealer that operates at relatively low temperatures with compatible bags.

### BACKGROUND OF THE INVENTION

Plastic bags may be used for storing a variety of items. To preserve the contents within the bag, it may be desirable to heat seal the bag using a heat sealing device. There are domestic vacuum sealing devices on the market that are able to heat seal plastic bags. The plastic bags must be compatible with the sealing device in order to form an effective hermetic seal. These devices typically operate at potentially dangerous temperatures and therefore, what is required is a system that can improve the safety of the existing systems.

### SUMMARY OF ONE EMBODIMENT OF THE INVENTION

Advantages of One or More Embodiments of the Present Invention

The various embodiments of the present invention may, but do not necessarily, achieve one or more of the following advantages: provide a system that is able to heat seal bags at reduced temperatures compared to prior art systems;

provide a bag that can be sealed at a reduced temperature;

provide a sealing machine that has a temperature limited to be compatible with a low temperature plastic bag.

These and other advantages may be realized by reference to the remaining portions of the specification, claims, and abstract.

Brief Description of One Embodiment of the Present Invention

In one aspect of the present invention, there is provided a composite film for forming a bag, the composite film comprising at least one structural layer, at least one tie layer, and at least one sealant layer. The at least one sealant layer may comprise a polyolefin plastomer that is able to form a hermetic seal at a 6 second dwell time at a temperature of no greater than 255 F.

In one aspect of the present invention, there is provided a bag comprising at least one layer of a multi-layer film, the multilayer film comprising a sealant layer, wherein the sealant layer comprises polyolefin plastomer.

In one aspect of the present invention, there is provided a method of sealing a bag comprising locating an open edge of the bag in a sealing machine comprising at least one heating element, applying heat from the at least one heating element along the at least one open edge of the bag at a temperature no greater than 255 F.

In one aspect of the present invention, there is provided a sealing machine for sealing at least one open edge of a bag, the sealing machine comprising a heating element for heating the sealant layer to form a welded seam, wherein the temperature of the heating element is limited to no greater than 255 F.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 substantially depicts a composite film comprising a low temperature sealant layer;

FIG. 2 substantially depicts an edge view of a bag comprising overlapping layers of the composite material of FIG. 1;

FIG. 3 substantially depicts a front view of a bag with welded edges and an open edge;

FIG. 4 substantially depicts a schematic of a sealing machine;

FIG. 5 substantially depicts a schematic of a heating element of the sealing machine; and

FIG. 6 substantially depicts a plot of seal strength versus sealing temperature for composite films having a low temperature sealant layer.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

The present invention relates to a heat sealable bag and sealing system, which may be a vacuum sealing system, that allows a low temperature sealing operation by comparison with prior art bags and sealing machines. In particular embodiments, the sealer in the bag sealing device may operate at no greater than 255 F, preferably at 240 F to 250 F. Bags may be produced to operate within these vacuum sealer machine parameters. By operating at lower temperature compared to prior art systems, there are energy saving, operator safety and environmental benefits. With reduced temperature lower energy is consumed and there is less chance of burning and injury to the operator which enhances safety. Further, a thinner thickness film can be used without burning through thereby making the film more environmentally friendly.

In one embodiment, a multi-layer film can include one or more structural or barrier layers, one or more tie layers, and one or more sealant layers. These layers may be coextruded as blown or cast films. Alternatively, the layers may be laminated using an adhesive between layers.

A bag may be manufactured from overlapping layers of the composite film, welded at the point of manufacture to seal the edges, leaving an opening. After filling the bag with suitable contents, an open edge of the bag may be later sealed by a user utilizing a domestic or commercial heat sealing machine to produce a fully sealed bag. The heat sealing machine may further incorporate a vacuum sealing element if vacuum sealing of the contents of the bag is desired.

Many forms of barrier and tie layers may be utilized depending on the required form, function and cost of the bag. The sealant layer may utilize a low temperature sealing material, such as an ethylene alpha-olefin resin, or other similar polyolefin plastomer. More generically, the sealant layer may be a resin with density of 0.912 or lower, preferably 0.905. Examples of a suitable polyolefin plastomer is the DOW AFFINITY, Elite™, Exceed™ and ExxonMobil Exact.

In one specific embodiment, a film is coextruded as blown or cast film using a skin layer of Nylon 6 and Nylon 66, tie layers to facilitate bonding of nylon to a Linear low-density polyethylene (LLDPE) resin and a skin layer of the polyolefin plastomer or polyolefin plastomer blended LLDPE as the sealant. This may be done as a 7 or 9 layer coextrusion Nylon/tie/LLDPE/tie/nylon/tie/sealant (either one or 3 layers depending on the die used).

In one embodiment, the sealant layer may be 100% of the polyolefin plastomer material. When the Dow Affinity product referred to above is used as the sealant layer, the film is able to form a hermetic seal at a sealing temperature of 240 F with a 6 second dwell time. In an alternative embodiment, a lower cost sealant layer may include a blend of the Dow 1880K product with a standard LLDPE material which is then extruded into the sealing layer. When blended at a 50% ratio, the 6 second dwell time temperature is no greater than 250 F, preferably 240 F to 250 F. The blended sealant layer lowers the cost of the bag without greatly increasing the sealing temperature and/or time required for the sealing operation.

A bag having a sealing layer including Dow Affinity, either pure or blended, is able to produce a hermetic, non-peelable, seal at temperatures of 240 F-245 F. Prior art films do not typically produce hermetic seals at these temperatures but just give a light tack seal that is peelable.

A bag having a lower sealing temperature facilitates the use of a sealing device that can also operate at lower temperatures which provides energy, safety and environmental benefits.

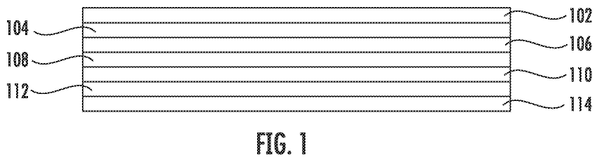

FIG. 1 depicts an example multi-layer film in accordance with an embodiment of the present invention. Layer 102 may be a nylon structural layer, layer 106 may be an LLDPE layer that gives the multi-layer film elasticity and/or extensibility. Between layer 102 and layer 106 is a first tie layer 104 which may be a polymer that bonds to nylon and LLDPE. A second nylon structural layer 110 is bonded to the LLDPE layer by a second tie layer 108. A sealant layer 114 is bonded to the second barrier layer 110 by a third tie layer 112 which is suitable for bonding the material of the sealant layer 114 to the second barrier layer 110. The sealant layer 114 includes the Dow 1880K product material. While only a single sealant layer is illustrated, as stated above multiple sealant layers may be utilized. In one embodiment, the minimum sealant layer thickness is 1 mil where a blend of Dow 1880K and cheaper resin is utilized.

In one embodiment, the preferred thickness of the layers is:

Nylon (30%); tie (15-20%); LLDPE (30%); sealant(20%).

While one specific layer construction is given, the person skilled in the art will recognize that other layer arrangements and materials may be utilized, in particular for the barrier and tie layers. The advantages of the preferred embodiments arise primarily from the incorporation of a low temperature sealant layer including a polyolefin plastomer material such as the Dow 1880K material described herein.

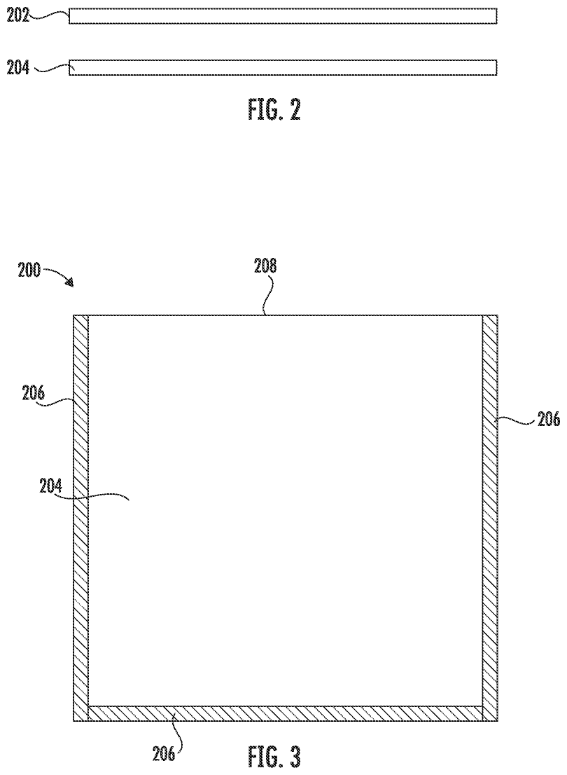

FIGS. 2 and 3 depict a bag 200 that may be manufactured from the composite film of FIG. 1. A first layer 202 of the film may be overlaid over a second layer 204 of the film, with the sealant layers being adjacent and edges substantially aligned. Alternatively, a single piece of the film material may be folded over itself to form two adjacent layers with the sealant layers in contact. A heat sealing machine may then form weld seams 206 around several edges of the bag 200, leaving an open end 208. The open end may provide access to an internal volume of the bag 200. The open end 208 may include one or more extensions or flaps that fold over the bag when sealing and facilitate later opening of the bag.

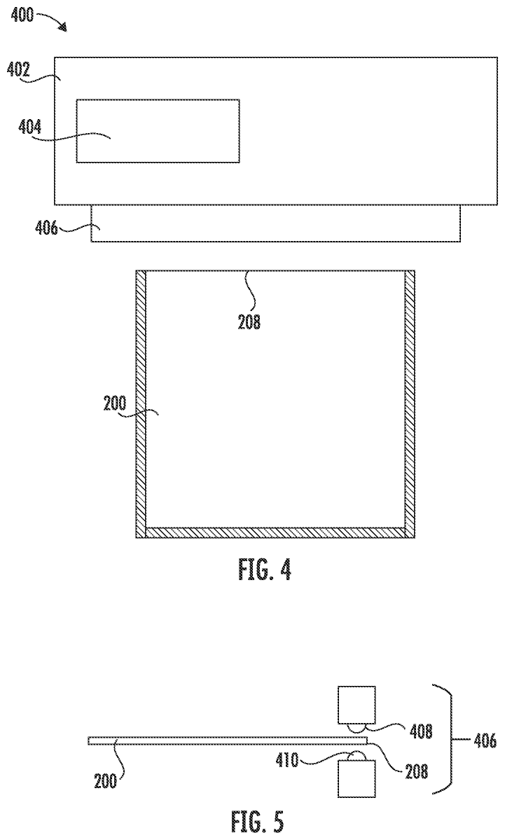

FIGS. 4 and 5 depict a sealing machine and sealing operation on a bag. The sealing machine 400 includes a housing 402 that houses electronics 404 and other operational components of the sealing machine. A heater system 406 receives an open edge 208 of a bag 200 to be sealed. Typically, the bag 200 will have been filled with contents that are to be contained in the bag. The heater system 406 includes a heater bar 408 that provides one side of a clamp for engaging the open edge 208 of the bag 200. An unheated second clamp 410 may be provided. The two clamp elements 408, 410 may be moveable toward each other to provide a pressure force to a bag located between the clamp elements 408, 410. In one embodiment, a pressure of approximately 18.4 pounds per square inch is applied to the contact area of the seal. The heater system is controlled by the electronics 404 to heat the heater bar 408, e.g. using a heating current, to a required temperature for sealing the bag 200. As is known in the art, the heating current required will be dependent on the resistance of the heater bar 408, which in turn depends on parameters of the heater bar such as the heater material, diameter of the material, etc. By locating the edge 208 between the clamp elements 408, 410, clamping the bag 200 and activating the heating bar 408, a weld seal may be created along the bag edge 208.

The sealing device 400 may be incorporated into a vacuum device that is able to draw air out of the bag 200 prior to sealing the bag. Vacuum sealing devices are known in the art, and the only substantial modification to such devices would be controlling the current through the heating elements to control the temperature of the heater bar to less than 255 F.

The sealing device 400 may be adapted to seal bags containing a variety of contents, including clothing, wet or dry foodstuffs, granular materials, etc.

The sealing machine 400 may be limited to control the temperature of the heater bar 408 to a temperature that is sufficient to seal the edges of the bag 200 containing a low temperature sealing layer, thereby providing a safer and potentially cheaper device than prior art sealing machines. In one embodiment, the sealing machine may limit the temperature of the heater bar to less than 255 F. In one embodiment, the sealing machine may limit the temperature of the heater bar to less than 250 F. In one embodiment, the sealing machine may limit the temperature of the heater bar to less than 245 F.

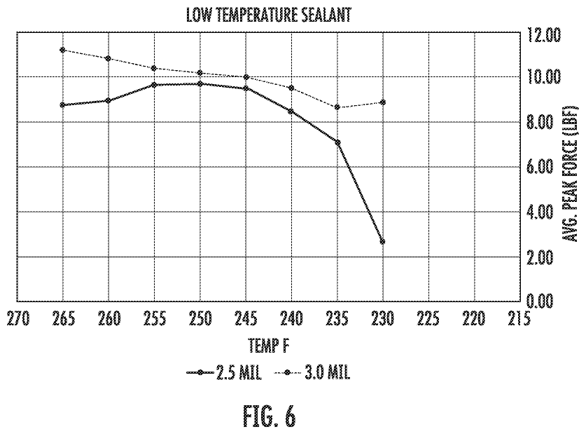

FIG. 6 shows a graph of the seal strength (represent by the force required to break the seal) versus the 6 second dwell time sealing temperature for bags of 2.5 mil and 3.0 mil having a 50% blended sealing layer. FIG. 6 demonstrates that at a sealing temperature of 240 F, the peak force required to break the seal remains above 8.0 LBF. At seal strengths of 8.0 LBF and above, the bag is considered to have formed a hermetic seal, though a hermetic seal may be formed at lower seal strengths. These curves are shifted right by typically at least 20 F when compared with prior art bags that do not incorporate low temperature sealing materials in the sealant layers.

Many modifications and other implementations of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific implementations disclosed, and that modifications and other implementations are intended to be included within the scope of the appended claims. Moreover, although the foregoing descriptions and the associated drawings describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A composite film for producing a bag, the film comprising:
(A) at least one structural layer;
(B) at least one tie layer; and
(C) at least one sealant layer, wherein the at least one sealant layer comprises a polyolefin plastomer that is able to form a hermetic seal for a 6 second dwell time at a temperature no greater than 255 F.

2. The film of claim 1 wherein the seal strength of the hermetic seal is at least 8.0 LBF.

3. The film of claim 1 wherein the at least one sealant layer is able to form a hermetic seal for a 6 second dwell time at a temperature no greater than 245 F.

4. The film of claim 1 wherein the at least one sealant layer comprises a blend of the polyolefin plastomer and a Linear low-density polyethylene (LLDPE) resin.

5. The film of claim 1 wherein the film comprises at least a seven layer construction comprising: nylon/tie/LLDPE/tie/nylon/tie/sealant.

6. The film of claim 1 wherein the polyolefin plastomer comprises an ethylene alpha-olefin resin.

7. The film of claim 1 wherein a density of the sealant layer is less than 0.912.

8. A sealing machine for sealing at least one open edge of a bag comprising the composite film of claim 1, the sealing machine comprising a heating element for heating the sealant layer to form a hermetic seal, wherein the temperature of the heating element is limited to not greater than 255 F.

9. A bag comprising at least one layer of a multi-layer film, the multi-layer film comprising:
(A) at least one structural layer;
(B) at least one tie layer; and
(C) at least one sealant layer, wherein the at least one sealant layer comprises a polyolefin plastomer that is able to form a hermetic seal for a 6 second dwell time at a temperature no greater than 255 F;
(D) wherein the bag comprises at least one sealed edge and at least one open edge that provides access to an internal volume of the bag.

10. The bag of claim 9 wherein the polyolefin plastomer comprises an ethylene alpha-olefin resin.

11. The bag of claim 9 wherein the bag comprises overlapping layers of the multi-layer film, wherein the respective sealing layers of the overlapping layers are adjacent.

12. The bag of claim 9 wherein the at least one sealant layer comprises a blend of the polyolefin plastomer and an LLDPE resin.

13. The bag of claim 9 wherein the multi-layer film comprises at least a seven layer construction comprising: nylon/tie/LLDPE/tie/nylon/tie/sealant.

14. A method for sealing a bag comprising:
(A) locating an open edge of the bag in a sealing machine comprising at least one heating element;
(B) applying heat from the at least one heating element along the at least one open edge of the bag at a temperature no greater than 255 F to form a hermetic seal at the open edge.

15. The method of claim 14 comprising applying heat for no greater than a 6 second dwell time.

16. The method of claim 15 comprising applying heat at a temperature no greater than 245 F.

17. The method of claim 14 wherein a strength of the hermetic seal is at least 8.0 LBF.

18. The method of claim 14 wherein the bag comprises at least one layer of a multi-layer film, the multi-layer film comprising:
(A) at least one structural layer;
(B) at least one tie layer; and
(C) at least one sealant layer, wherein the at least one sealant layer comprises a polyolefin plastomer that is able to form a hermetic seal for a 6 second dwell time at a temperature no greater than 255 F.

19. The method of claim 18 wherein the bag comprises overlapping layers of the multi-layer film, wherein the respective sealing layers of the overlapping layers are adjacent.

20. The method of claim 18 wherein the at least one sealant layer comprises a blend of the polyolefin plastomer and an LLDPE resin.
